(19) United States
(12) Patent Application Publication
(10) Pub. No.: US 2011/0186482 A1
(43) Pub. Date: Aug. 4, 2011

(54) STRUCTURE AND WORKING METHOD FOR THE SORTING OF WASTE PRODUCTS

(75) Inventor: Lourens Zwart, Arnhem (NL)

(73) Assignee: Orig LLC

(21) Appl. No.: 12/982,283

(22) Filed: Dec. 30, 2010

(30) Foreign Application Priority Data
Dec. 30, 2009 (NL) 1037598

(51) Int. Cl. B07B 4/02

(52) U.S. Cl. 209/3.1; 209/639; 209/552

(57) ABSTRACT

An apparatus for the separation of waste paper includes a slanted conveyor belt with a lower end and an upper end, the upper end being positioned at a height above the lower end, the conveyor belt traveling from the lower end to the upper end. A plurality of drive mechanisms drive the slanted conveyor belt. At least one load mechanism supplies the waste paper at the lower end of the conveyor belt. At least one air pressure system is positioned adjacent to the upper end of the conveyor belt. The plurality of drive mechanisms provide a minimum speed of 3 meters per second.

### CROSS-REFERENCE TO RELATED APPLICATION(S)

This application claims priority to the Dutch application number 1037598 which was filed Dec. 30, 2009, which is hereby incorporated by reference in its entirety.

### FIELD OF THE INVENTION

The invention is in regards to a structure for the sorting of waste paper, comprising a slanted conveyor belt with drive mechanisms, load mechanisms to deposit raw material mixture at the low end of the conveyor belt, and air pressure equipment placed nearer the upper end of the conveyor belt.

### DESCRIPTION OF RELATED ART

Arrangements of this type are known. They are used to separate waste paper into different components which can be marketed separately. The price that may be obtained for these separate paper components is influenced by its homogeneity, quality, and absence of non-paper components. This because the buyer, usually a paper trader, distributor, manufacturer, converter, requires a constant quality. For this the buyer needs to know as accurately as possible the quality and properties of the offered wastepaper. In presently used constructions, waste paper is placed and transported upwards on a conveyor belt. The waste paper is then dropped from the end of the conveyor belt. Air pressure equipment separates the falling paper, whereby the more compact components will spread less then loose leafs and light folders. The speed of the conveyor belt is regulated to avoid the paper on the belt from becoming airborne, and this is usually at around 2 meters per second.

The problem with these presently used constructions-is-that-they hardly separate from one another the folders, newspaper and magazines that comprise the waste paper. Folders, newspapers and magazines all remain as compact components, and are hardly separated by the air flow. This is especially the case with folded newspapers, which have many of the characteristics of magazines.

### SUMMARY OF THE INVENTION

The apparatus of the invention is specifically intended to create and sort a mixture of loose sheets, folders, newspapers and magazines, with at least one distinguishing feature that the motors of the conveyor belt are adjusted to operate at a speed of at least 3 meters per second. Consequently the higher transport speed results in loose sheets quickly becoming airborne, and the folders, newspapers and magazines start to tumble when they hit the conveyor belt, increasing the chance that they partially open up, and consequently obtain a larger surface area. For a magazine the surface area in relation to the weight is limited. Therefore, the air pressure will have more influence on the airborne folder and newspaper materials, which consequently will be blown a longer distance.

Another aspect of the invention is that the conveyor belt is outfitted with cross bars to cause the falling folders, newspapers and magazines to tumble, thus further increasing the open surface area of the materials. Due to the high speed of the belt, folders and/or newspapers have the tendency to lay dormant, which is alleviated by the cross bars. With the passing over every bar the folders and/or newspapers receive an additional impulse to tumble, again increasing the unfolding of these materials. Heavier magazines will not be effected and remain flat on the conveyor belt, further aiding the separation.

The invention also has as characteristic that the construction is fitted with additional air pressure and/or air vacuums fitted to at least one side of the conveyor belt, placed above the surface of the conveyor belt and positioned to blow over/above the surface of the conveyor belt.

to the air pressure and/or vacuum devices separate the loose sheets, folders and newspapers that have become airborne from the conveyor belt and/or those paper products that opened sufficiently to be separated in this phase of the process.

The invention also includes the characteristic that the air pressure is placed below the upper end of the conveyor belt, in the form of a fan with a large surface area, as well as an air knife. The fan performs the actual separation, while the air knife causes the loose leaf pages, folders, newspapers or magazines that have come free of the conveyor belt to again tumble, therefore further opening these materials and increasing the probability that they will be dispersed by the fan. By preference, the air knife will be placed lower than the end of the conveyor belt. This is to prevent the airborne sheets from gathering at the air knife and causing a blockage.

Another aspect of the invention is that the air knife has a. stopcock (airflow shutter) and control mechanism to regulate pulsing airflow. By causing a pulsating airflow, only a part of each sheet, folder, newspaper or magazine is struck by the airstream. This causes the folder, newspaper or magazine to tumble wilder.

The invention therefore has a characteristic that the stopcock (shutter) may be opened at arbitrary moments, for short periods of time, to permit intermittent airflow to the air knife.

The invention can include detection equipment placed at the upper end to signal to the air knife that material is approaching on the conveyor belt. Thus, the air knife is activated only when a loose sheet, folder, newspaper or magazine approaches the upper end of the conveyor belt.

The detection equipment can suffice with a simple light source and receptor (motion detector). Eventually, the detection equipment can also be triggered by optical recognition in the form of paper brightness and/or reflection (gloss).

The invention entails a reduction in the amount of air passing through the air knife and optimizes the tumbling of the folder, newspaper or magazine by connecting the detectors to the air knife. The detectors activate the swift opening and dosing (pulse or burst) of the air knife when the upper or lower end of an object leaves the conveyor belt. As a result the object is struck by air from the air knife in a defined area.

The invention entails an air knife that consists of a series of nozzles in row, connected to detectors in row, each with a stopcock (airflow switch or regulator) which activates the airburst when the aligned detector detects the upper or lower end of an object.

The invention is also related to the method of sorting waste paper, through the use of equipment as outlined herein.

### BRIEF DESCRIPTION OF THE DRAWINGS

The invention is further described in connection with the following sketches (drawings), where:

FIG. 1 is a side view of a prior art apparatus;

FIG. 2 is a side view of a first design of the present invention, to separate folders, newspapers and magazines;

FIG. 3 is a side view of a second design of the present invention, which is constructed to separate folders, newspapers and magazines;

FIG. 4 is a side view of a third design of the present invention, which is constructed to separate folders, newspapers and magazines;

FIG. 5 is a side view of a fourth design for the present invention, which is constructed to separate folders, newspapers and magazines.

### DETAILED DESCRIPTION OF EMBODIMENT(S) OF THE INVENTION

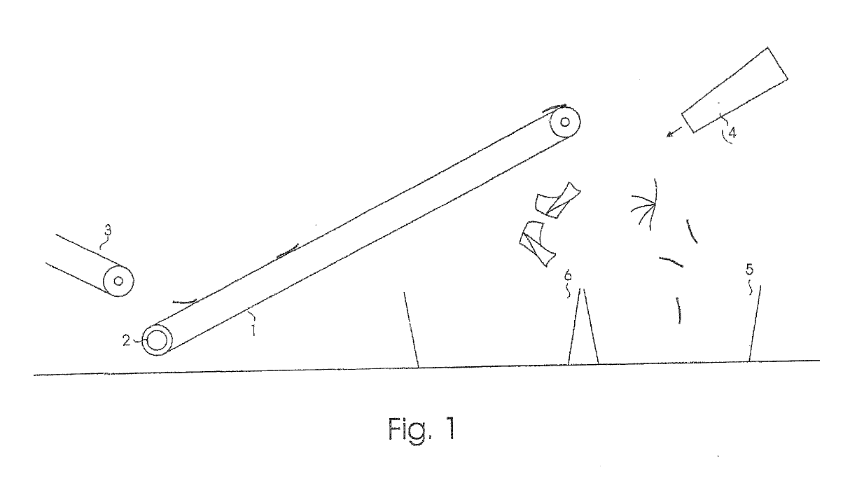

FIG. 1 is a side view of a layout for an apparatus for the separation of waste paper as presently in use (current technology), which mainly separates loose sheets and light folders from the remainder of paper materials. The equipment consists of a slanted conveyor belt 1, connected to drive mechanisms 2, configured such that the conveyor belt 1 transports the sheets, folders, newspapers and magazines with a speed of, for example, 2 meters per second. Furthermore, the equipment consists of a conveyor belt 3 to place a mix of different waste papers on the lower end of conveyor belt 1, with a fan 4 placed near the upper end of the conveyor belt 1. The fan 4 separates the falling mixed waste paper by blowing air thereon. In this case heavier folders, newspapers and magazines will fall straight down from the upper end of the conveyor belt 1 and into a container 5. Loose sheets, light folders and single sheet newspaper will land in container 6, having been pushed by the airflow from fan 4. The drop characteristics of folded folders, newspapers and magazines vary only slightly, causing a problem when attempting to further separate these materials from one another.

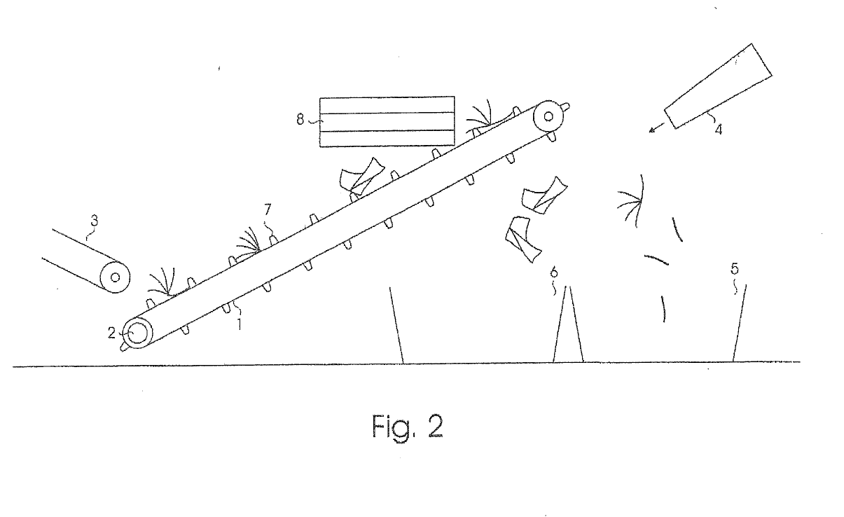

FIG. 2 depicts one embodiment of the invention including a layout for separating folders, newspapers and magazines based on altering the drop characteristics of these paper materials by increasing their surface areas. The construct consists of a slanted conveyor belt 1, connected to drive mechanisms 2, a conveyor belt 3 to drop a mix of folders, newspapers and magazines onto conveyor belt 1, and a fan 4 at the top end of the conveyor belt 1 that blows air onto the folders, newspapers and magazines falling from the top end of the conveyor belt. The drive mechanism 2 is adjusted to transport books and heavier magazines with a speed of 3 to 8 meters per second, Due to this relatively high speed, the folders, newspaper and lighter magazines will start to tumble, causing them to open. This effect can be magnified by providing the conveyor belt 1 with cross bars 7. The moment the folders, newspapers and magazines fall from conveyor belt 3 onto conveyor belt 1, the cross bars 7 interact with the paper materials and cause them to tumble, increasing the probability that they will fan open. It is then possible to blow the paper materials through fan S over the side of the conveyor belt 1, to fall into a container (bin), which is not shown in FIG. 1.

Instead of a fan 8, it is also possible to rely upon a vacuum system to collect the folders, newspapers and loose sheets from the conveyor belt 1. Also, a combination could be installed, in which a fan 8 blows the folders and newspapers from one side of the conveyor belt 1 into a vacuum collector placed on the opposite side of conveyor belt 1. Folders and newspapers that are not blown and collected remain on the conveyor belt 1 to fall off of the end, where mainly magazines fall into container (bin) 5 and folders and newspapers mainly fall into container (bin) 6.

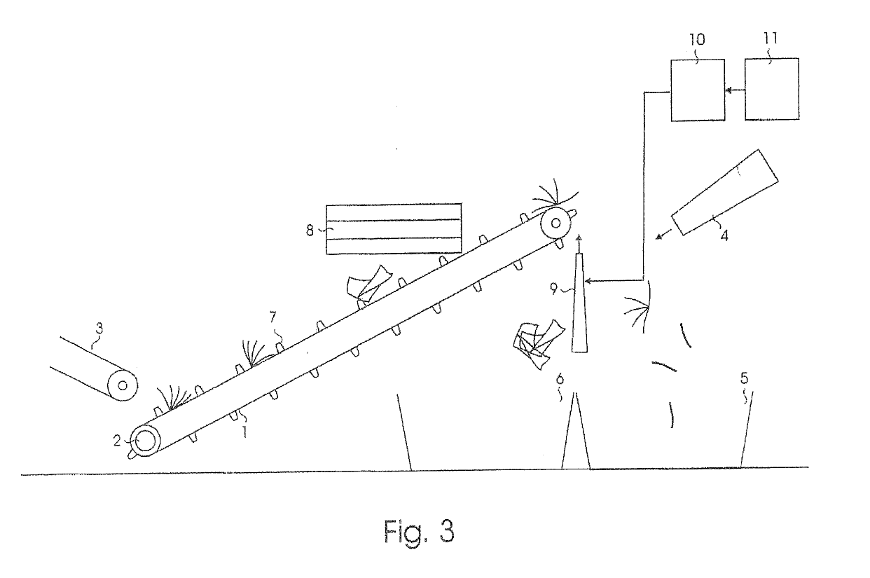

FIG. 3 depicts a second embodiment of the invention for separating folders, newspapers and magazines similar to the layout depicted in FIG. 2. In this embodiment, however, at the end of conveyor belt 1, an air knife 9 is positioned. The air knife 9 generates a powerful, narrow, and upwardly pointed stream of air over a width nearly equal to the width of conveyor belt 1. This causes folders, newspapers and magazines to tumble when they fall of off the end of conveyor belt 1. Especially for newspapers, this tumbling motion further unfolds the newspapers, increasing their surface area so that a large part of these newspapers will be blown by fan 4 into the container (bin) 6. In the layout depicted by FIG. 3, the air knife 9 is connected to a stopcock (airflow switch or regulator) 10 and a control mechanism 11, which regulates the airflow, in short bursts, emitted/discharged from air knife 9. From these directed bursts, only a part of each folder, newspaper or magazine is struck, increasing the tumbling of these paper materials.

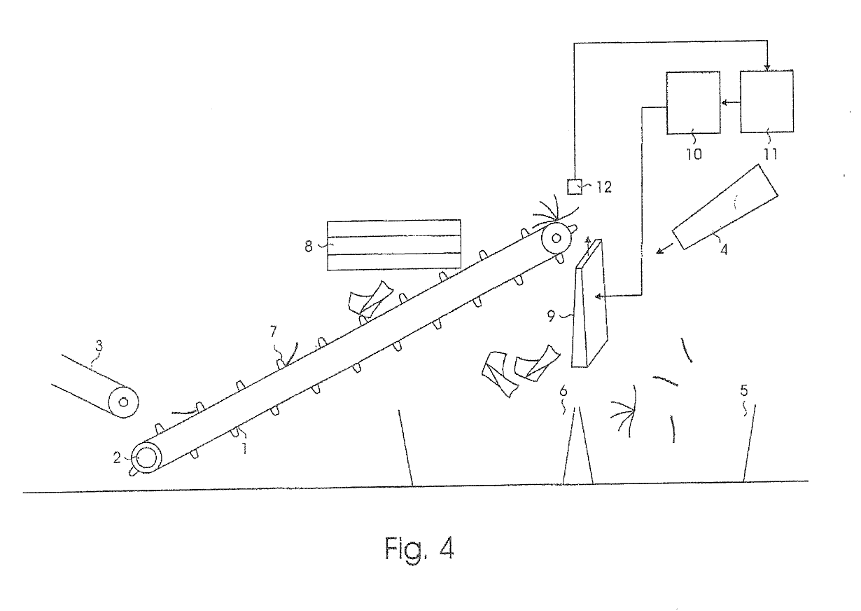

FIG. 4 depicts the layout of a third embodiment of the present invention for separating folders, newspapers and magazines. This embodiment is similar to the embodiment shown in FIG. 3, with the addition, to the control mechanism 11, of the described detector 12, through which steering mechanism 11 can detect when a folder, newspaper or magazine has reached the end of conveyor belt 1. The steering mechanism 11 can then instruct the air knife 9 to emit a short pulse at the moment that the leading or trailing edge of the object (folder, newspaper or magazine) trips the detector 12. The folder, newspaper or magazine struck by the blast of air on the front or rear end will cause additional intensified tumbling, and cause additional amount of newspaper to be blown by the fan 4 into the container (bin) 6.

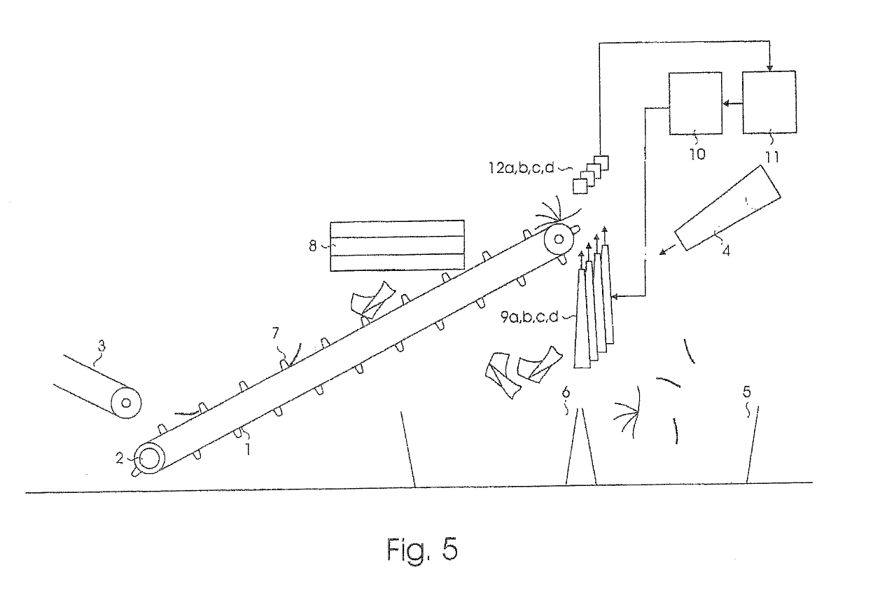

FIG. 5 depicts a fourth embodiment of a layout of the apparatus of the present invention for separating folders, newspapers and magazines. This embodiment is similar to the embodiment of FIG. 4, with the addition of a control mechanism 11 for a series of in-line detectors 12 a, b, c, and d, through which steering mechanism 11 can detect when a folder, newspaper or magazine has reached the upper end of conveyor belt 1. The air knife consists of a series of the previously described nozzles 9a, b, c, and d arranged in a line, through which the steering mechanism 11 can regulate pulsed air at such time that the folder, newspaper or magazine leading or following edge will be struck by the air discharged therefrom. This will result in a minimum of compressed air causing maximized tumbling, and subsequently an even larger amount of newspaper being blown by the fan 4 into container the (bin) 6.

1. An apparatus for the separation of waste paper, comprising:
a slanted conveyor belt with a lower end and an upper end, the upper end being positioned at a height above the lower end, the conveyor belt traveling from the lower end to the upper end;
a plurality of drive mechanisms driving the slanted conveyor belt;
at least one load mechanism supplying the waste paper at the lower end of the conveyor belt; and
at least one air pressure system disposed adjacent to the upper end of the conveyor belt,
wherein the plurality of drive mechanisms provide a minimum speed of 3 meters per second.

2. The apparatus of claim 1, further comprising:
a plurality of cross bars fitted on the slanted conveyor belt.

3. The apparatus of claim 2, further comprising:
at least one of a plurality of air fans or a plurality of air vacuums placed along at least one side of the slanted conveyor belt, above the slanted conveyor belt, to direct air across the surface of the conveyor belt.

4. The apparatus of claim 1, further comprising:
an air fan with large surface area and an air knife positioned below the upper end of the conveyor belt.

5. The apparatus of claim 1, wherein an air knife is positioned below the upper end of the conveyor belt.

6. The apparatus of claim 5, further comprising:
a shutcock operative connected to the air knife to control the flow of air discharged by the air knife; and
a steering mechanism operatively connected to the shutcock to control operation of the shutcock and, thereby, to regulate air flow discharged by the air knife.

7. The apparatus of claim 6, wherein the steering mechanism regulates the air flow in short bursts.

8. The apparatus of claim 6, further comprising:
a plurality of detection devices, positioned to detect objects at the upper end of the conveyor belt.

9. The apparatus of claim 8, wherein the plurality of detectors are operatively connected to the steering mechanism of the air knife and are adjusted to provide short air blasts the moment the leading or trailing edge of an object leaves the upper end of the slanted conveyor belt.

10. The apparatus of claim 9, wherein the air knife is fitted with a row of separate nozzles, each individually outfitted with shutcocks to regulate the air flow the moment that the plurality of detectors detect the leading or trailing edge of an object.

11. (canceled)

12. A method of separating waste paper, comprising:
supplying waste paper to a lower end of a slanted conveyor belt, wherein the lower end is at a height below an upper end;
driving the slanted conveyor belt at a minimum speed of 3 meters per second; and
applying at least one of an air flow or an air vacuum adjacent to the upper end of the slanted conveyor belt, thereby encouraging at least a portion of the waste paper to expose a surface area sufficient for separation from a bulk of the waste paper; and
separating at least the portion of the waste paper from the bulk of the waste paper via the at least one of the air flow or the air vacuum.

13. The method of claim 12, wherein the slanted conveyor belt comprises a plurality of cross bars that facilitate tumbling of the waste paper thereon.

14. The method of claim 12, wherein a plurality of air fans or a plurality of air vacuums apply at least one of the air flow or the air vacuum adjacent to the upper end of the slanted conveyor belt at a position above an upper surface of the slanted conveyor belt, such that the air flow or air vacuum is applied across the upper surface of the slanted conveyor belt.

15. The method of claim 12, further comprising:
applying a pulsed air flow to the waste paper via an air knife positioned adjacent to the upper end of the slanted conveyor belt, wherein the air flow is provided in controlled bursts.

16. The method of claim 15, further comprising:
detecting at least one or a leading edge or a trailing edge of an object within the waste paper via at least one detector, wherein the controlled bursts are timed according to an output from the at least one detector.
